(19) United States
(12) Patent Application Publication
(10) Pub. No.: US 2012/0072355 A1
(43) Pub. Date: Mar. 22, 2012

(54) SYSTEM AND METHOD FOR PROVIDING AND UPDATING SHIPPING INFORMATION

(75) Inventors: Matthew Scrafford, Fairfort, NY (US); Jason Tsongas, Rochester, NY (US)

(73) Assignee: Xerox Corporation

(21) Appl. No.: 12/884,412

(22) Filed: Sep. 17, 2010

(51) Int. Cl. G06Q 10/00

(52) U.S. Cl. 705/304; 705/333

(57) ABSTRACT

A system and method for providing and updating shipping information with respect to a supply order. A supply order with respect to a shipping package can be placed into a helpdesk unit via a client device. A tracking number with respect to the supply order can be entered into the client device in order to retrieve the current status of the supply order. The helpdesk unit can contact a shipping company via an application programming interface and provide an end customer with latest information regarding the current status of the supply order directly on a client device local user interface. Such information can be updated on a regular basis via an Internet connection back to the shipper's application programming interface.

### TECHNICAL FIELD

Embodiments are generally related to shipment management systems and methods. Embodiments are additionally related to the provision of shipping information with respect to a supply order.

### BACKGROUND OF THE INVENTION

Shipping and receiving of packages is a common activity among consumers and businesses. Such activities involve providing information associated with the package (e.g., recipient, address, etc.), providing the package to a shipping provider (e.g., drop off, pickup, etc.), assignment of a tracking number, and delivery of the package to the recipient.

Most prior art approaches for tracking shipping information enable the customer to vocally communicate (e.g., via a telephone) with a “help desk” for obtaining the status information of an ordered package. A problem with such a service, however, is that it is very labor intensive and relies on skilled and trained agents to handle all the requests. Additionally, the burden of updating data can readily be quantified into terms of increased operation costs, which vendors sometimes pass onto their customers. Such prior art approaches therefore result in additional call volume and customer dissatisfaction and is time-consuming and prone to error.

Based on the foregoing, it is believed that a need exist for an improved system and method for providing and updating shipping information with respect to a supply order, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved shipment management system and method.

It is another aspect of the disclosed embodiments to provide for an improved system and method for providing and updating shipping information with respect to a supply order.

The aforementioned aspects and other objectives and advantages can now be achieved as described herein. A system and method for providing and updating shipping information with respect to a supply order is disclosed herein. The supply order with respect to a shipping package can be placed into a helpdesk unit via a client device (e.g., a rendering device). A tracking number with respect to the supply order can be entered into the client device in order to retrieve the current status of the supply order. The helpdesk unit can contact a shipping company via an application programming interface (API) and provide an end customer with latest information regarding the current status of the supply order directly on a client device local user interface. Such information can be updated on a regular basis via an internet connection back to the shipper's API.

The tracking number can be generated by entering a ticket associated with the supply order into the centralized helpdesk unit and the shipping company provides the tracking number to the helpdesk unit. An extensible interface platform (EIP) application associated with the client device can be accessed by an end user in order to list all supply order requests that have been submitted to the helpdesk unit. The status information associated with the supply order includes shipped date, current location, expected delivery date, carrier, tracking number, and an authorized signatory. The helpdesk unit also provides details regarding the ordered supply item such as the description, part number, and updated shipping information directly at the client device local user interface. Such an approach provides enhanced package shipping and receiving services and enables the user to easily access information related to the supply order. The system and method provides an improved cost of delivery for managed print services through more accurate service level agreement monitoring, reduced help desk support calls, and tighter supply usage tracking.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a tracking module, an operating system, and a user interface, in accordance with the disclosed embodiments;

FIG. 3 illustrates a block diagram of a shipping information tracking system, in accordance with the disclosed embodiments;

FIG. 4 illustrates a high level flow chart of operation illustrating logical operational steps of a method for providing shipping information with respect to a supply order, in accordance with the disclosed embodiments; and

FIGS. 5-6 illustrate a GUI illustrating a current status of the supply order in association with a tracking number, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

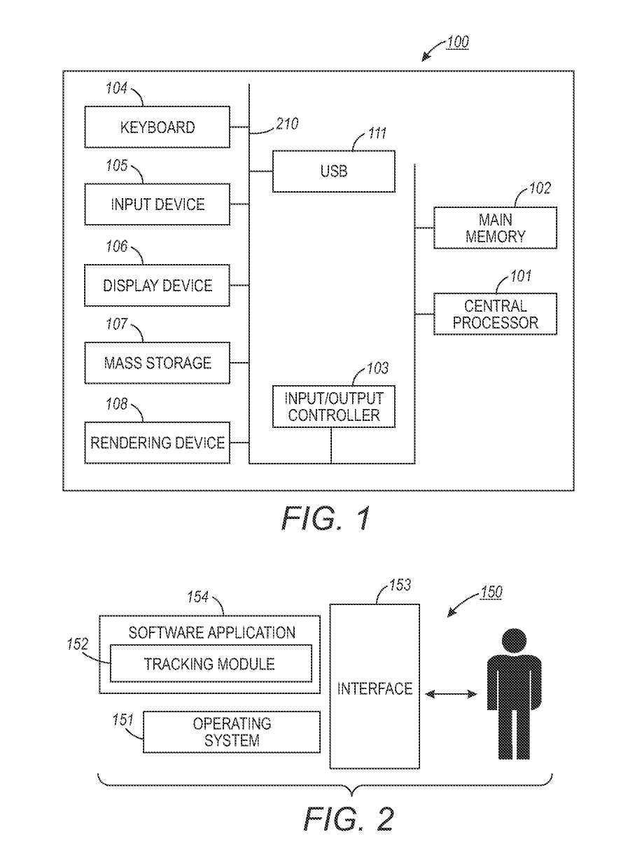

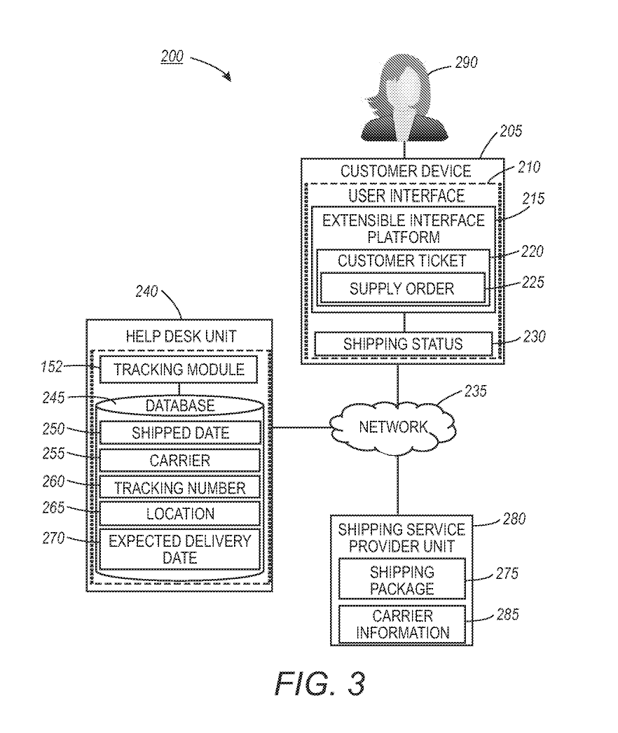

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, pen device, etc.), a display device 106, a mass storage 107 (e.g., a hard disk), and a USB (Universal Serial Bus) peripheral connection 111. Additional input/output devices, such as a rendering device 108 (e.g., printer, scanner, fax machine, etc), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc.

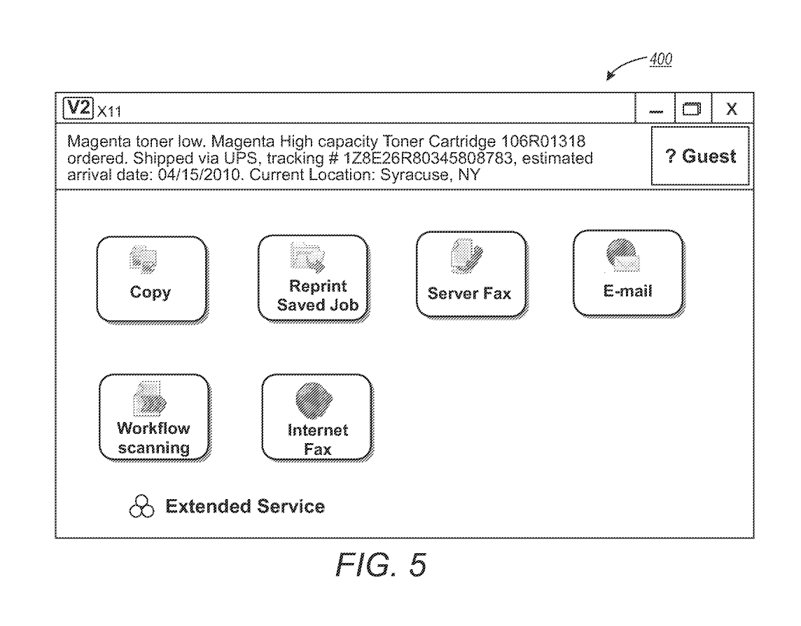

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of operating systems and interfaces may be alternatively utilized. For example, rather than a traditional “Windows” system, other operation systems such as, for example, Linux may also be employed with respect to operating system 151 and interface 153. The software application 154 can include, for example, a tracking module 152 for providing shipping information with respect to a shipping package. The tracking module 152 can include instructions such as those of method 300 discussed herein with respect to FIG. 4.

FIGS. 1-2 are thus intended as an example and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms including Macintosh, UNIX, LINUX, and the like.

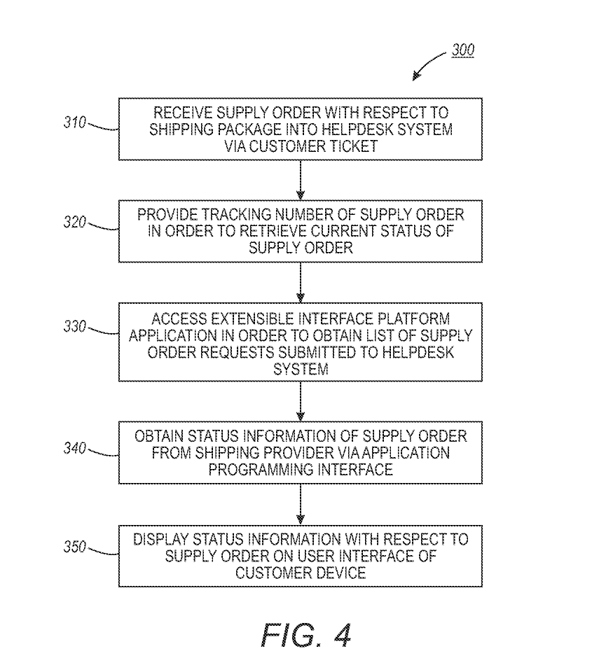

FIG. 3 illustrates a block diagram of a shipping information tracking system 200, in accordance with the disclosed embodiments. Note that in FIGS. 1-5, identical parts or elements are generally indicated by identical reference numerals. The tracking system 200 provides shipping status information 230 with respect to a shipping package 275. The tracking system 300 generally includes a customer device 205, a helpdesk unit 240 and a shipping unit 280 that are operatively communicated via a network 235. The customer device 205 may comprise a desktop computer, a rendering device, or any other messaging or communication device with sufficient resources to support communications with other devices via a communications network 235. The communications network 235 in the preferred embodiment comprises the Internet. Accordingly, the customer device 205 is able to communicate with the helpdesk unit 240 and the shipping unit 280 via the communications network 235.

Note that the network 235 can be an Internet connection representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages. Of course, network 235 may also be implemented as a number of different types of networks.

The customer device 205 includes an extensible interface platform (EIP) application 215 for generating a customer ticket 220 with respect to the shipping package 275. Note that the customer device 205 can be the rendering device 108 that includes a user interface. In some embodiments, rendering device 108 may be a rendering device such as a printer, scanner, copy machine, etc. In other embodiments, rendering device 108 may be a MFD. The extensible interface platform 215 can be a software platform upon which a developer utilizes standard web-based tools to create server-based applications that can be configured for the rendering device user interface 210. The shipping system 280 typically includes a shipping package 275 and carrier information 285 with respect to the shipping package 275. The customer 290 typically accesses the EIP application 215 to place a supply order 225 with respect to the shipping package 275 into the helpdesk unit 240 by generating the customer ticket 220.

The helpdesk unit 240 including the tracking module 152 further places the supply order 225 with respect to the shipping package 275 into the shipping unit 280 in order to obtain a tracking number 260 with respect to the supply order 225. The helpdesk unit 240 automatically places the supply order 225 or can be performed manually. The shipping unit 280 provides the tracking number 260 associated with the supply order 225 to the helpdesk unit 240. The helpdesk unit 240 also includes a database 245 for storing shipping information such as, for example, a shipped date 250, a current location 265, an expected delivery date 270, a carrier 255, and a tracking number 260 with respect to the supply order 225.

The tracking number 260 with respect to the supply order 225 can be further entered into the customer device 205 in order to retrieve the current status of the supply order 225. The EIP platform 215 associated with the customer device 205 thereby provides a list of supply order requests that have been submitted to the helpdesk unit 240. The helpdesk unit 240 further contacts the shipping company 280 via an application programming interface (API) and provides the customer 290 with the latest information regarding the current status 230 of the supply order 225 directly on the user interface 210 of the customer device 205. Such information can be updated on a regular basis via the Internet connection back to the shipper's API.

In general, API is an interface implemented by a software program, which enables it to interact with other software. An API is implemented by applications, libraries, and operating systems to determine their vocabularies and calling conventions, and is used to access their services. It may include specifications for routines, data structures, object classes, and protocols used to communicate between the consumer and the implementer of the API. The helpdesk unit 240 also provides details regarding the shipping package 275 such as the description and part number in order to update the updated shipping information directly at the customer device local user interface (UI) 210. The status information 230 can also be viewed at the helpdesk unit 240.

FIG. 4 illustrates a high level flow chart of operation illustrating logical operational steps of a method 300 for providing shipping information with respect to the supply order 225, in accordance with the disclosed embodiments. Note that the method 300 can be implemented in the context of a computer-useable medium that contains a program product including, for example, a module or group of modules. The supply order 225 with respect to the shipping package 275 can be received from the customer 290 via the helpdesk unit 240 in order to place the supply order 225 into the shipping unit 280, as illustrated at block 310. The tracking number 260 with respect to the supply order 225 can be provided to the helpdesk unit 240 in order to retrieve the current status 230 of the supply order 225, as depicted at block 320.

The extensible interface application 215 platform can be accessed in order to obtain the list of supply order requests submitted to the helpdesk unit 240, as indicated at block 330. Note that the list of supply order requests may be selected and/or “dragged and dropped” to “select” a customer specific supply order or otherwise access functionality related to an enhanced shipping and receiving system. Such functionality may include, for example, preparing a new shipping request for a package, editing a shipping request, checking notifications, and checking package status based on the orders.

The status information 230 with respect to the supply order 225 can be obtained from the shipping unit 280 via the application programming interface, as illustrated at block 340. Such supply information with respect to the supply order 225 can be directly displayed at the user interface 210 of the customer device 205, as depicted at block 350. The system and method therefore provides enhanced package shipping and receiving services and enable customers to easily access information related to one or more packages in the shipping environment.

Note that programs defining functions with respect to the disclosed embodiments may be delivered to a data storage system or a computer system via a variety of signal-bearing media which include, without limitation, non-writable storage media (e.g., CD-ROM), writable storage media (e.g., hard disk drive, read/write CD ROM, optical media, USB drive, Flash memory, DVD-R, etc.), system memory such as, but not limited to, Random Access Memory (RAM), and communication media such as computer and telephone networks including, for example, Ethernet, the Internet, wireless networks, and other networked systems. Thus, the method 400 described herein can be deployed as process software in the context of a computer system or data-processing system as that depicted in FIGS. 1-2.

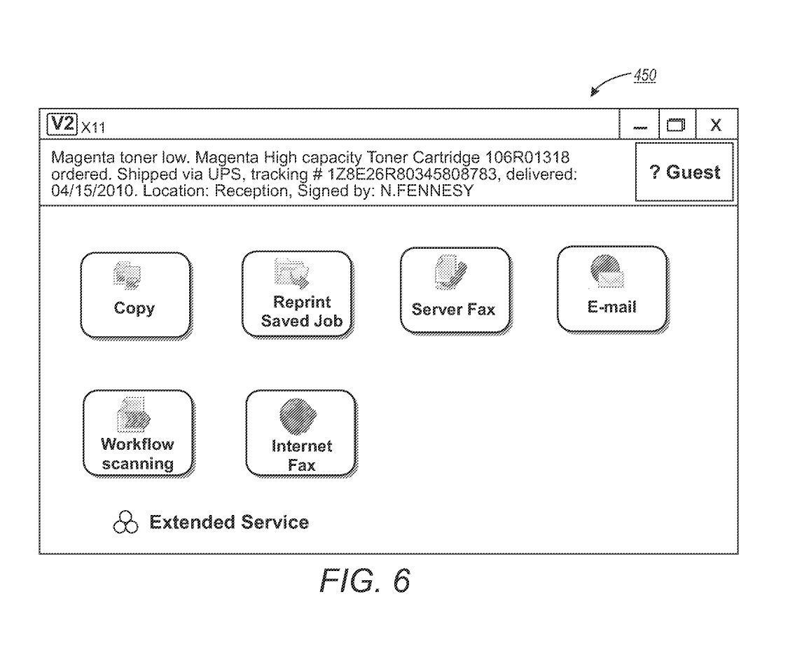

FIGS. 5-6 illustrate GUI 400 and 450 illustrating the current status of a supply order in association with a tracking number, in accordance with the disclosed embodiments. Note that the GUI 400 and 450 can be implemented utilizing a GUI such as, for example, the GUI 153 depicted in FIG. 2 herein, and may be provided by a module such as, for example, module 152 (i.e., a software application). GUI 400 and 450 can be displayed via a display device such as display 106 depicted in FIG. 1. In the illustrated figures herein, the depicted GUI 400 and 450 can be implemented in the context of a GUI “window”. Note that in computing, a GUI window is generally a visual area containing some type of user interface (e.g., GUI 153). Such a “window” usually (but not always) possesses a rectangular shape and displays the output of and may allow input to one or more processes. Such windows are primarily associated with graphical displays where they can be manipulated with a mouse cursor such as, for example, the pointing device 105 depicted in FIG. 1. A GUI using windows as one of its main “metaphors” is often referred to as a windowing system.

The GUI 400 illustrates the status information 230 including tracking number 260 and expect delivery data 270 associated with the supply order 225 that is not yet delivered to the customer 290. The GUI 450 illustrates the status information 230 including the tracking number 260 and authorized signatory information with respect to the supply order 225 that is delivered to the customer 290. The system and method provides an improved cost of delivery for managed print services through more accurate service level agreement monitoring, reduced help desk support calls, and tighter supply usage tracking.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for providing shipping information, comprising:
entering a tracking number with respect to a supply order into a client device in order to retrieve the current status with respect to said supply order; and
retrieving latest information regarding said current status with respect to said supply order directly on a local user interface associated with said client device by contacting a shipping company via an application programming interface.

2. The method of claim 1 further comprising placing a supply order with respect to a shipping package into said helpdesk unit in order to thereafter generate said tracking number by entering a ticket associated with said supply order into said help desk unit.

3. The method of claim 1 further comprising accessing an extensible interface platform application associated with said client device in order to list a plurality of supply order requests submitted to said helpdesk unit.

4. The method of claim 1 further comprising viewing said shipping information with respect to said supply order on said user interface associated with said client device.

5. The method of claim 1 further comprising updating said status information with respect to said supply order on a regular basis via an internet connection back to said application programming interface associated with said shipping company.

6. The method of claim 1 wherein said status information comprises at least one of the following information:
a shipped date;
a current location;
an expected delivery date;
a carrier; and/or
an authorized signatory.

7. The method of claim 1 further comprising configuring said helpdesk unit to provide at least one of the following details:
a description with respect to said supply order; and
a part number with respect to said supply order.

8. The method of claim 1 wherein said customer device comprises a rendering device.

9. A system for providing shipping information, said system comprising:
a processor;
a data bus coupled to said processor; and
a computer-usable medium embodying computer code, said computer-usable medium being coupled to said data bus, said computer program code comprising instructions executable by said processor and configured for:
entering a tracking number with respect to a supply order into a client device in order to retrieve the current status with respect to said supply order; and
retrieving latest information regarding said current status with respect to said supply order directly on a local user interface associated with said client device by contacting a shipping company via an application-programming interface.

10. The system of claim 9 wherein said instructions are further configured for placing a supply order with respect to a shipping package into said helpdesk unit in order to thereafter generate said tracking number by entering a ticket associated with said supply order into said help desk unit.

11. The system of claim 9 wherein said instructions are further configured for accessing an extensible interface platform application associated with said client device in order to list a plurality of supply order requests submitted to said helpdesk unit.

12. The system of claim 9 wherein said instructions are further configured for viewing said shipping information with respect to said supply order on said user interface associated with said client device.

13. The system of claim 9 wherein said instructions are further configured for updating said status information with respect to said supply order on a regular basis via an internet connection back to said application programming interface associated with said shipping company.

14. The system of claim 9 wherein said status information comprises at least one of the following information:
a shipped date;
a current location;
an expected delivery date;
a carrier; and/or
an authorized signatory.

15. The system of claim 9 wherein said instructions are further configured for modifying said helpdesk unit to provide at least one of the following details:
a description with respect to said supply order; and
a part number with respect to said supply order.

16. The system of claim 9 wherein said customer device comprises a rendering device.

17. A system for providing shipping information, said system comprising:
a processor;
a data bus coupled to said processor; and
a computer-usable medium embodying computer code, said computer-usable medium being coupled to said data bus, said computer program code comprising instructions executable by said processor and configured for:
entering a tracking number with respect to a supply order into a client device in order to retrieve the current status with respect to said supply order;
retrieving latest information regarding said current status with respect to said supply order directly on a local user interface associated with said client device by contacting a shipping company via an application programming interface; and
viewing said shipping information with respect to said supply order on said user interface associated with said client device

18. The system of claim 17 wherein said instructions are further configured for placing a supply order with respect to a shipping package into said helpdesk unit in order to thereafter generate said tracking number by entering a ticket associated with said supply order into said help desk unit.

19. The system of claim 17 wherein said instructions are further configured for accessing an extensible interface platform application associated with said client device in order to list a plurality of supply order requests submitted to said helpdesk unit.

20. The system of claim 17 wherein said customer device comprises a rendering device.
